(19) United States
(12) Patent Application Publication
(10) Pub. No.: US 2005/0163418 A1
(43) Pub. Date: Jul. 28, 2005

(54) Single-level no-crossing microelectromechanical hitless switch for high density integrated optics

(76) Inventors: Chee Wei Wong, New York, NY (US); Lionel C. Kimerling, Concord, MA (US)

Correspondence Address: Guthier & Connors LLP, Suite 3300, 225 Franklin Street, Boston, MA, 02110, US

(21) Appl. No.: 10/833,453

(22) Filed: Apr. 28, 2004

Related U.S. Application Data
(60) Provisional application No. 60/538,736, filed on Jan. 23, 2004.

(51) Int. Cl. G02B 6/26

(52) U.S. Cl. 385/16; 385/42

(57) ABSTRACT

An optical switch includes at least two signal bus waveguides that receive optical signals as input. At least two directional couplers are positioned so that the inputs to the at least two directional couplers are not switched relative to each other.

### PRIORITY INFORMATION

This application claims priority from provisional application Ser. No. 60/538,736 filed Jan. 24, 2004, which is incorporated herein by reference in its entirety.

### BACKGROUND OF THE INVENTION

The invention relates to the field of high-integrated optics, and in particular to a hitless switch for high-density integrated optics.

Electro-optic channel waveguide modulators and switches are potentially important circuit components for optical fiber communications systems because they are efficient and can be operated at high frequencies. A distinct advantage of channel waveguide devices is that they are suitable for direct coupling to optical fibers since the guided light wave is well confined in bother transverse dimensions. Also, the power required for waveguide modulators is much lower than for bulk modulators.

Single channel electro optic modulators in which the phase of the propagating light wave is modulated have fabricated in LiTaO₃ and ZnS and ZnSe. Coupling between these devices and an optical fiber is hindered because a polarization analyzer is required at the waveguide output to transform phase modulation to intensity modulation. This constraint can be relieved by direct intensity modulation of the optical signal. It has been demonstrated that amplitude modulation in a GaAs planar waveguide configuration. Direct amplitude modulation in channel waveguides has recently been observed in LiNbO₃ GaAs by applying a voltage so as to cause a localized increased in the refractive index sufficient to trap the input light.

An electro-optic directional coupler switch comprises two parallel strip line waveguides forming a passive directional coupler with an electro-optic pad at the edge of each waveguide. Initially light is focused onto one of the waveguides and the amount of light coupled to the adjacent channel can be controlled electro-optically. This scheme only permits direct amplitude modulation of the light propagating in one channel, but allows light to be switched from one channel to another.

### SUMMARY OF THE INVENTION

According to one aspect of the invention, there is provided an optical switch. The optical switch includes at least two signal bus waveguides that receive optical signals as input. At least two directional couplers are positioned so that the inputs to the at least two directional couplers are not switched relative to each other.

According to another aspect of the invention, there is provided a method of forming an optical switch. The method includes providing at least two signal bus waveguides that receive optical signals as input. Also, the method includes positioning at least two directional couplers so that the inputs to the at least two directional couplers are not switched relative to each other.

### BRIEF DESCRIPTION OF THE DRAWINGS

FIG. 1 is a schematic diagram illustrating the inventive hitless switch;

FIG. 2 is a schematic diagram illustrating a beam propagation path before MEMS perturbation;

FIG. 3 is a graph demonstrating signal power against various δ/κ ratios;

FIG. 4 is a graph demonstrating the extinction ratio in the bypass region against various δ/κ ratios;

FIG. 5 is a graph and schematic diagram illustrating the designed κ values for various gap separations, s, and designed δ for various gap regions, d, and thicknesses, t, of a dielectric slab;

FIG. 6A is a schematic diagram illustrating an in-plane sliding actuator mechanism; FIG. 6B is a scanning electron micrograph of the comb-drives used in the in-plane sliding actuator mechanism shown in FIG. 6A;

FIG. 7 is a graph illustrating signal loss from asymmetric MEMS perturbation against various δ/κ ratios;

FIG. 8 is a graph demonstrating signal loss due to deviation from ideal π-phase shift against various δ/κ ratios, wherein the deviation arises from actual device fabrication;

FIG. 9 is a graph demonstrating signal loss from asymmetric directional couplers against various δ/υ ratios;

FIGS. 10A-10B are two-dimensional finite-difference time-domain diagrams verifying the expected properties of the inventive switch; and

FIGS. 11A-11C are process flow diagrams illustrating the formation of the optical switch.

### DETAILED DESCRIPTION OF THE INVENTION

A new concept of achieving a hitless switch for high-density integrated optics is described herein. The need for a hitless switch stems from the finite reconfiguration time necessary for tuning optical add/drop multiplexers. Within this finite time (order of milli- to micro-seconds) information bits will be lost or mixed in the high-bandwidth optical channel. Therefore, there is a requirement to switch the information from a signal bus waveguide to another “bypass” waveguide, without any loss of bits, while the reconfiguration is being performed on devices attached to the signal bus waveguide. When the reconfiguration is complete, the signal is transferred back to the signal bus waveguide without any loss of bits.

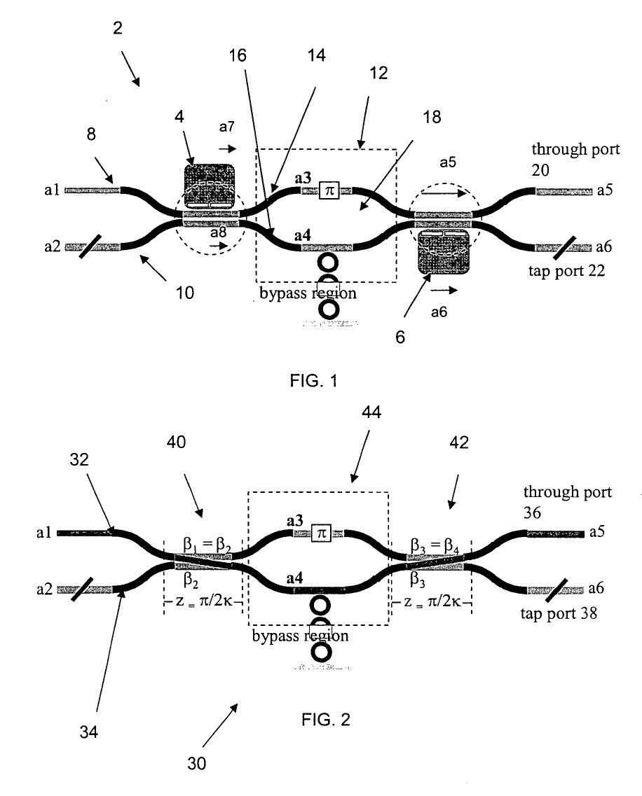

FIG. 1 illustrates an exemplary hitless switch 2 in accordance with the invention. The hitless switch 2 includes two cascaded directional couplers 4, 6, two input signal bus waveguides 8, 10, and a bypass region 12. The first input signal bus waveguide 4 inputs a signal a1 and the second signal bus waveguide 10 input a signal a2. The signal a1 and a2 are inputted to the directional coupler 4. The bypass region 12 receives the output signals a7 and a8 of the directional coupler. The bypass region 12 includes a Mach Zehnder structure 18. The two arms 14, 16 of the Mach Zehnder structure 18 form bypass waveguides that receive as input the output signals a7 and a8 of the directional coupler 4. The bypass region 12 performs finite reconfiguration time operations on signals a7 and a8, and produces output signals a3 and a4 that are provided to the second directional coupler 6. The second directional coupler 6 further processes the signals a3 and a4 and produces output signals a9 and a10. The output signals a5 and a6 are provided to the throughput port 20 and tap port 22.

The hitless switch 2 differs from that used in the prior art because the inputs of the second direction coupler 6 does not need to be switched relative to the inputs of the first directional coupler 4. Note the directional couplers 4, 6 include microelectromechanical perturbations to perform their processing. Moreover, the microelectromechanical dielectric slab perturbs the waveguide mode on the same vertical plane, through a sliding motion of the dielectric slab. The microelectromechanical (MEMS) dielectric perturbation gives a phase mismatch, and hence detuning, of the directional coupler. The inventive designs described herein permit a hitless switch to be constructed in a single-level, permitting reductions in device micro- and nano-fabrication complexity. This translates to improvements in device yield, reduction in costs and manufacturing completion time.

Other alternatives for an integrated hitless switch include an alternating-Δβ optical waveguide coupler. In these alternatives, the directional couplers are typically electro-optically switched. The switched directional couplers can also be surface waves generated through a transducer, differing from the usage of dielectric slab perturbation. Finally, bypass switches in free-space optics with MEMS micromirrors have been suggested for optical fiber data distribution, though these developments do not use the switched directional couplers discussed herein and are not feasible for high-density integrated optics.

FIG. 2 shows a beam propagation path 30 that does not use MEMS perturbation. As shown in FIG. 2, a signal al enters at the signal bus waveguide 32 and exits at the through port 36 with a signal a5. In FIG. 2, the couplers 40, 42 are designed for the minimum conversion length, z=π/2κ, where κ is the waveguide coupling coefficient, such that there is complete crossover of the light from one guide to the other. The fields in the coupled waveguides can be modeled through coupled mode theory. For example, the field amplitudes a3 and a4 in the bypass region 44, as shown in FIG. 2, are
a3(z)/e^{-iβz}=a1(cos βₒz−i(δ/βₒ)sin βₒz+a2(κ₁₂/βₒ)sin βₒz (1)
a4(z)/e^{-iβz}=a1(κ₂₁/βₒ)sin βₒz+a2(cos βₒz+i(δ/βₒ)sin βₒz (2)
where a1, a2=the field amplitudes are the two input guides 32, 34, κ₁₂=−κ₂₁*=κ, βₒ=(δ²+κ²)^{0.5}, δ=(β₁−β₂)/2, β=(β₁+β₂)/2, β_{and β}₂ the propagation constants in waveguide 32 and 34 respectively.

The coupling coefficient κ is estimated through a mode solver, and the design verification is done through finite-difference time-domain numerical computations. The signals a5, a6 in the through port 36 and tap port 38 can be found by repeating equations (1) and (2) for the second directional coupler 42, with a3 and a4 replacing a1 and a2 as the inputs. The extinction ratio is defined as |a4|²/|a3|². With the MEMS perturbation such that δ=3^{1/2}κ, there is zero net crossover of signal from signal bus waveguide to the coupled waveguide.

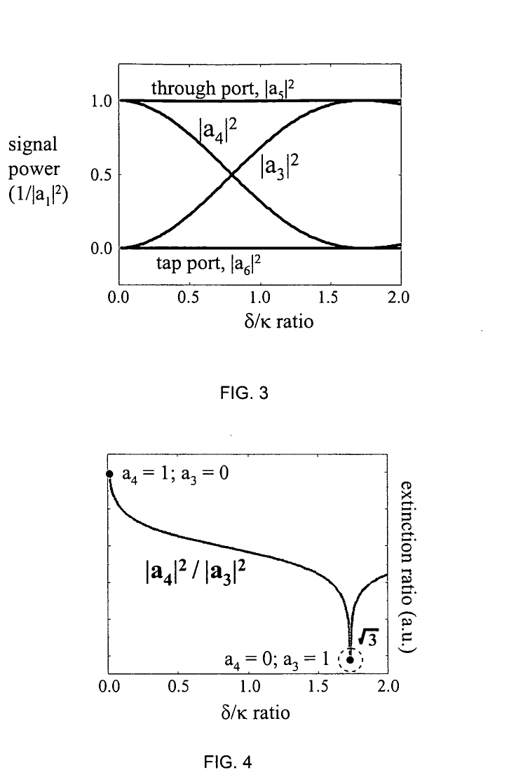

The calculated signal power, normalized by the input power |a1|², is shown in FIG. 3 for various δ/κ ratios. The resulting extinction ratio is also shown in FIG. 4.

Note that the coupled mode theory formalism predicts zero crosstalk for δ=0 when switching in one designed directional coupler. However, a very low, but finite, crosstalk is expected due to the index perturbation necessary for switching. Design for low crosstalk is, therefore, desirable in the adiabatic separation of the couplers. Scattering losses in the waveguides could also contribute to the crosstalk degradation.

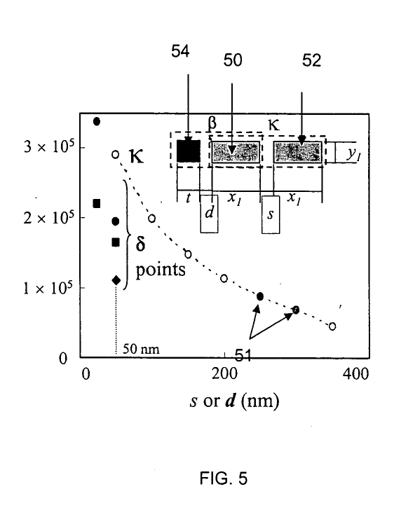

As an example, a SiNₓ material system is chosen (refractive index n˜2.2) to form two signal bus waveguides 50, 52 shown in FIG. 5 with a width x_{L} of approximately 700 nm and a thickness y_{L} of approximately 300 nm for single-mode guidance. The gap separation s between the waveguides 50, 52 is approximately 250 nm. This provides a coupling coefficient of approximately 88×10³ which translates to a coupling length of approximately 17.8 μm. For a4=0 and a3=1, as shown in FIGS. 1 and 2, the perturbation δ is approximately 152×10³. This perturbation δ is achievable through MEMS. This is calculated using a mode-solver. The perturbation slab has a thickness, t, of approximately 450 nm and a gap d of approximately 50 nm. A summary of the designed results are also shown in FIG. 5.

As shown in FIG. 5, the coupling coefficient drops exponentially with increasing gap d. More importantly, FIG. 5 shows we can design perturbation δ with magnitude on order of the required 3^{1/2}κ using MEMS perturbation to achieve complete phase mismatch in the directional couplers. Examples of two selected gaps d for the directional coupler are also shown at points 51 in FIG. 5, with d=250 and 300 nm respectively. With these d dimensions, the perturbation δ can be easily designed for sufficient mismatch on the directional couplers.

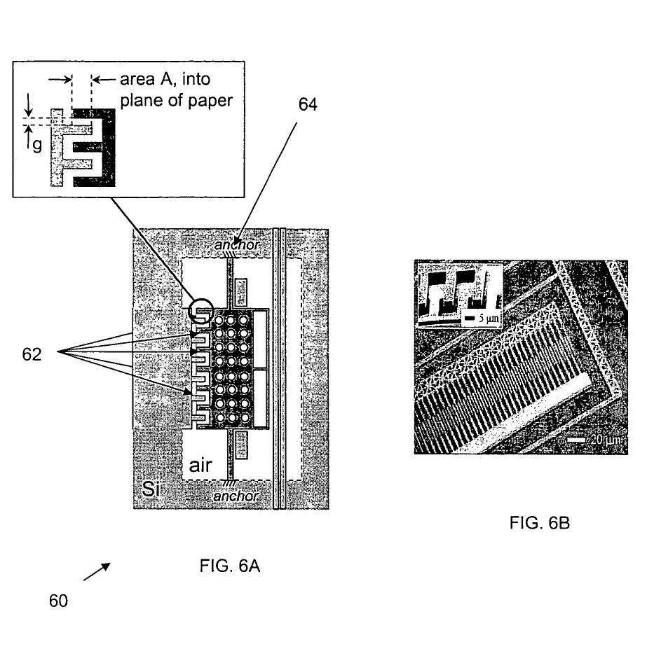

An in-plane sliding actuator mechanism 60, as shown in FIG. 6A, can be used to form the necessary perturbation discussed herein. The in-plane sliding actuator 60 includes interdigitated comb-drive “fingers” 62 that are actuated by applying a differential voltage between the fingers 62, shown in FIG. 6A. The electrostatic attractive force is mainly due to the fringing fields. In this comb-drive actuator 60, the capacitance (expressed with first-order accuracy as εA/g, where ε is the permittivity of the medium surrounding the comb-drive fingers 62) is varied through changing the area A linearly, instead of the gap g nonlinearly between two parallel capacitance plates. The elements A and gap g are shown in more detail in FIG. 6A. The result is an actuator force approximately proportional to the square of the applied voltage. Compared to a parallel capacitance plate actuator mechanism, electrostatic comb-drives 62 have better controllability since it is less susceptible to pull-in instability from the positive feedback in parallel capacitance plate designs. Capacitive position sensing could also be performed. A scanning electron micrograph of the comb-drives are shown in FIG. 6B.

The supporting beams 64 can be designed for sufficient stiffness on order of 0.5 N/m, cantilever lengths of order 150 μm, widths of order 5 μm, and thickness of order 0.3 μm, for order 1 μm displacement resolution of the perturbing dielectric slab. Following this example, the number of comb-drive finger pairs 62 is on order of 50, with a gap of 1 μm between the fingers, and applied voltages between 1 V for a 1 nm displacement and 50 V.

During actual device fabrication and operation, the device geometry and perturbation deviates from ideal theoretical design. The sensitivity from imperfect fabrication and operation, caused by: (i) asymmetric MEMS perturbation, (ii) variation in π-phase shift, and (iii) asymmetric directional couplers are described hereinafter. These variations results in a loss in through port signal.

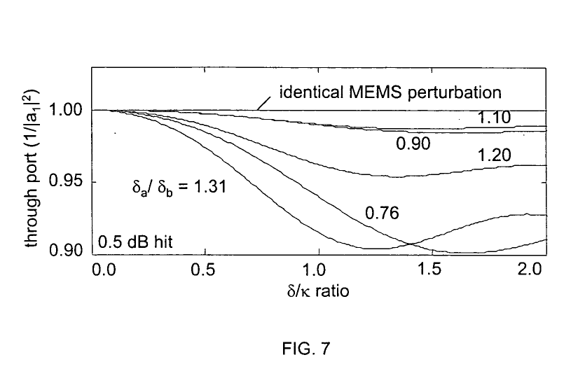

Asymmetric MEMS perturbation arises when the two dielectric slabs do not arrive at exactly the same time and position. FIG. 7 illustrates the through port signal (normalized by |a1|²) for various δ/κ ratios. The various lines refer to different magnitudes of asymmetry, such as when the first perturbing slab having δₐ 31% larger than the second perturbing slab δ_{b}. From FIG. 7, it is observed that if the two MEMS perturbing slabs are controlled within 0.76 to 1.31 times of each other, we get a 0.5 dB signal loss in the through port. The sensitivity is nonlinear, however; for larger asymmetries, the signal loss is significantly larger.

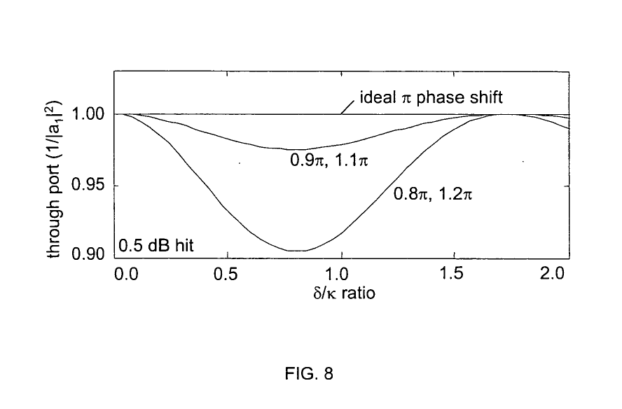

Secondly, the effects of variations in the π-phase shift is illustrated in FIG. 8. The variation arises either from asymmetry in the two waveguides arms causing different phase delays or from different input signal frequencies, since the π-phase shift is geometrically designed for one particular frequency. For a ±20% variation from the ideal π-phase shift, a 0.5 dB hit is predicted; for a ±1.3% variation, a negligible (less than 0.01 dB) hit is predicted. The 1.3% deviation in π-phase shift arises from operation in the C-band (˜1530 to 1570 nm) with the device designed for operation at 1550 nm.

In addition, each directional coupler has a frequency dependence between 1530 to 1570 nm, ranging from 5-10% variation of the coupling κ at 1550 nm. However, even if conversion lengths are designed only for operation at 1550 nm, the two cascaded directional couplers as a whole is broadband. Operating away from 1550 nm, there is incomplete crossover (“leakage”) at the first directional coupler but this leakage is destructively interfered at the output of the second directional coupler.

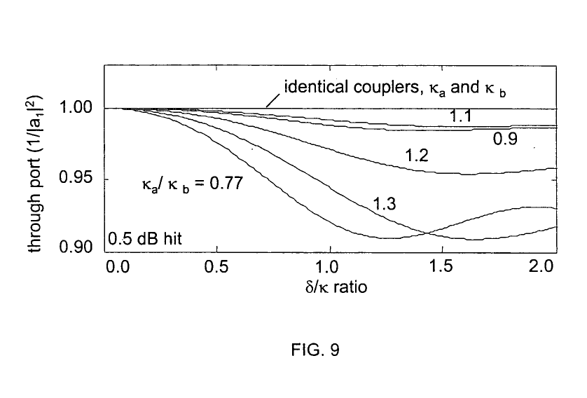

Thirdly, the effects of asymmetric couplers are described in FIG. 9. For a threshold signal loss of 0.5 dB, for example, the device can tolerate a differential variation between κₐ and κ_{b} of approximately 0.77 to 1.30 times of each other.

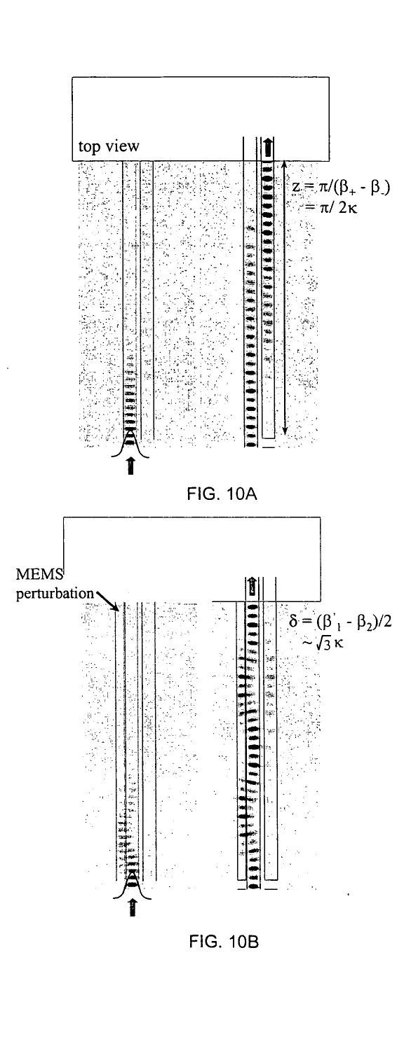

Finite-difference time-domain (FDTD) calculations, as shown in FIGS. 10A-10B, are performed to verify the results from coupled mode theory and the mode solver. The FDTD is performed in 2-dimensions with the effective index determined from a perturbation approach. FIG. 10A shows complete crossover for the designed conversion length of 15.1 μm in the designed directional coupler, with specific dimensions described. When perturbed with δ˜3^{1/2}κ (d=50 nm and t=450 nm), a zero net crossover is observed. This is illustrated in FIG. 10B. This confirms the validity of the device concept and design.

By removing the need to switch inputs of DCM2 to inputs of DCM1 and designing the MEMS dielectric perturbation on the same vertical plane of the waveguides, the device implementation can be reduced to a single-level—with a single lithography step—as described in this invention. This permits reductions in device micro- and nano-fabrication complexity. This also translates to improvements in device yield, reduction in costs and manufacturing completion time.

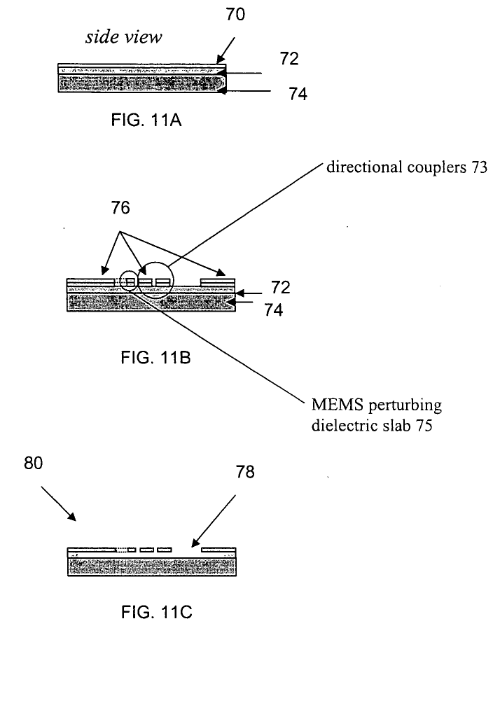

The fabrication process flow, showing the top view and side profile of the invention, is illustrated in FIGS. 11A-11B. For a SiNₓ material system, the first step is to deposit low-pressure chemical-vapor-deposition nitride 70 on a silicon dioxide layer 74. Note the silicon dioxide layer 74 is form on a substrate 72. Note a Si material system having a 200 nm Unibond Silicon-On-Insulator wafer can be used in place of the SiNₓ, material system. The SOI wafer can include a Si top layer, silicon dioxide layer, and substrate. The second step is to define the device geometry with an electron-beam lithography step, as shown in FIG. 11B. Note a Cr layer 76 is deposited on the top layer 70 the SiNx. This step concurrently defines the directional couplers 73, the MEMS dielectric slabs 75, and other structures such as the waveguides, supporting structure, and the electrostatic comb-drives. If electron-beam lithography is not used, a photoresist layer can be used to form the device geometry. The final step is to release the MEMS structure through a buffered oxide etch 78 that removes the oxide 74 underneath the MEMS structure, as shown in FIG. 11C. This step also removes the cladding underneath the directional couplers.

Although the present invention has been shown and described with respect to several preferred embodiments thereof, various changes, omissions and additions to the form and detail thereof, may be made therein, without departing from the spirit and scope of the invention.

1. An optical switch comprising:
at least two signal bus waveguides that receive optical signals as input; and
at least two directional couplers that are positioned so that the inputs to said at least two directional couplers are not switched relative to each other.

2. The optical switch of claim 1 further comprising a bypass region that performs finite reconfiguration time operations on output signals received from one of said at least two directional couplers.

3. The optical switch of claim 2, wherein said bypass region comprises a π-phase shift device in one of the arms of the Mach-Zehnder configuration.

4. The optical switch of claim 1, wherein one of said at least two directional couplers provides outputs signals to a through port and a tap port.

5. The optical switch of claim 1, wherein said at least two directional couplers comprises a MEMS perturbation device that is on the same vertical plane as the at least two signal bus waveguides.

6. The method of claim 5, where said MEMS perturbation device provides strong perturbation with proximity switching, permitting complete phase mismatch of the directional couplers.

7. A method of forming an optical switch comprising:
providing at least two signal bus waveguides that receive optical signals as input; and
positioning at least two directional couplers so that the inputs to said at least two directional couplers are not switched relative to each other.

8. The method of claim 6 further comprises proving a bypass region that performs finite reconfiguration time operations on output signals received from one of said at least two directional couplers.

9. The method of claim 7, wherein said bypass region comprises a π-phase shift device in one of the arms of the Mach-Zehnder configuration.

10. The method of claim 6, wherein one of said at least two directional couplers provides outputs signals to a through port and a tap port.

11. The method of claim 6, wherein said at least two directional couplers comprises a MEMS perturbation device that is on the same vertical plane as the at least two signal bus waveguides.

12. The method of claim 10, wherein said MEMS perturbation device provides strong perturbation with proximity switching, permitting complete phase mismatch of the directional couplers.
